(19) United States
(12) Patent Application Publication
(10) Pub. No.: US 2005/0202374 A1
(43) Pub. Date: Sep. 15, 2005

(54) Hypoxia awareness training system

(76) Inventors: Jan Stepanek, Rochester, MN (US); Thomas E. Belda, Rochester, MN (US); Curtis F. Buck, Painview, MN (US); Steven R. Holets, Oronoco, MN (US); Randolph W. Stroetz, Rochester, MN (US); Jeffrey S. Kallis, Rochester, MN (US)

Correspondence Address: SHUMAKER & SIEFFERT, P. A., 8425 SEASONS PARKWAY, SUITE 105, ST. PAUL, MN, 55125, US

(21) Appl. No.: 11/030,586

(22) Filed: Jan. 6, 2005

Related U.S. Application Data
(60) Provisional application No. 60/534,628, filed on Jan. 6, 2004.

(51) Int. Cl. G09B 9/02; G09B 19/16; G09B 9/08

(52) U.S. Cl. 434/37; 434/29

(57) ABSTRACT

A hypoxia awareness training system provides education on high altitude flight physiology and simulates atmospheric oxygen concentrations found normally at sea level and at high altitudes. It can be programmed to reduce oxygen levels to correspond with specific altitudes. The rate of change in simulated altitude (oxygen reduction) can be programmed to correspond with normal ascent rates of specific aircraft, thus providing a platform for training pilots to recognize symptoms of themselves or their crewmates under hypoxic conditions. This training is not limited by geographic location and can be performed in a safe and controlled environment, where poor judgment and coordination will not result in disaster.

This application claims the benefit of U.S. Provisional Application Ser. No. 60/534,628, filed Jan. 6, 2004, the entire content of which is incorporated herein by reference.

### TECHNICAL FIELD

The invention relates to systems for hypoxia awareness training.

### BACKGROUND

Hypoxia is defined as the lack of sufficient oxygen supply to the body cells or body tissues caused by an inadequate supply of oxygen, inadequate transportation of oxygen, or inability of the body tissues to utilize the oxygen. Altitude hypoxia is an insidious and hazardous physiological threat to flight crew when flying at altitude. This type of hypoxia is caused by a decreased partial pressure of oxygen in the ambient atmosphere at altitude.

Hypoxia manifests itself in three phases. The first phase is the phase of general slowing. This phase may be characterized by subjective feelings of warmth, tingling of extremities, decreased ability to concentrate, fatigue, mild hyperventilation, mild apathy, mild alterations in handwriting, and sometimes a mild change in the color of the lips or the tongue. The next phase, the error phase, may be characterized by lethargy, mistakes on simple tasks, lack of self-critique with overestimation of one's capabilities, pronounced fatigue, headache, nausea, and sweating. Loss of color vision, alterations in handwriting (alignment, size, legibility), and marked indifference are also hallmarks of this second phase. Finally, the third phase, referred to as the failure phase, predates final loss of consciousness. The failure phase typically manifests with paleness, a bluish appearance of the lips, tongue, and fingers, some shaking and mild muscle twitching, complete apathy, and then finally loss of consciousness. It should be noted that the symptoms of hypoxia are, by their very nature, quite insidious. Often the victim is not only unaware that they have been overtaken by hypoxia, but also the lack of self-critique and overestimation of ones capabilities that are hallmarks of hypoxia lead the victim to believe that they are actually able to perform quite well.

Various types of hypoxia awareness training have been used to train aviation personnel to experience and recognize the signs and symptoms of hypoxia. These signs and symptoms tend to be reproducible for each individual upon repeat exposures to a hypoxic environment. During hypoxia awareness training, the test subject is exposed to a hypoxic environment in a controlled fashion, in hopes that they will learn to recognize hypoxia symptoms in themselves and/or their crewmates should they occur during an actual flight and take appropriate action before incapacitation occurs.

Exposure to hypobaric environments via hyperbaric chamber is the most commonly used method of hypoxia awareness training. However, only a limited number of hyperbaric structures at fixed locations are available. Significant travel time to one of the hyperbaric structures is therefore required each time an individual must undergo hypoxia training. This tends to make chamber training expensive and inefficient. In addition, because the hyperbaric chamber is pressurized, there is an increased risk of decompression sickness (DCS) or dysbarism when undergoing chamber training.

### SUMMARY

In general, the invention is directed toward a hypoxia awareness training system. The system exposes a test subject to a reduced oxygen breathing paradigm in order to simulate the effects of a hypoxic environment under controlled conditions. The system may be a standalone device or may be configured to provide hypoxia awareness training via a network, such as the Internet. When exposed to a hypoxic environment in a controlled fashion, the subject may experience hypoxic conditions and become familiar with their own subjective signs and symptoms of hypoxia. These signs and symptoms tend to be reproducible upon repeat exposures to hypoxic environments. The rationale for hypoxia awareness training is, therefore, the hope that aviation personnel will recognize hypoxia symptoms in themselves or their crewmates should they occur during an actual flight and take appropriate measures before incapacitation occurs.

The system may include at least one video camera for capturing video of the test subject during the training session. The system may also include a document camera for capturing video of a document on which the test subject performs psychomotor testing during the hypoxia awareness training session. The video of the test subject and the video of the document, as well as the flight profile being simulated, and/or other applicable information may be displayed during the training session. This information may also be stored for review by the test subject in a post-simulation debriefing or for review at some future date. By capturing, displaying, and storing the entire training session experience, the test subject may be able to understand, learn, and retain much more information concerning the signs and symptoms of hypoxia in themselves and/or their crewmates. In addition, the training provided by the hypoxia awareness training system described herein is not limited by geographic location and can be performed in a safe and controlled environment, where poor judgment and coordination will not result in disaster.

In one embodiment, the invention directed to a hypoxia awareness training system including a reduced-oxygen breathing unit that induces hypoxia in a test subject during a training session, and a pilot camera that captures video of the test subject during the training session. The system may also include a document camera that captures video of writings of test subject during the training session. The system may also include a display may display the video of the test subject during the training session and/or the video of the writings of the test subject during the training session.

In another embodiment, the invention is directed to a method, which includes inducing hypoxia in a test subject during a hypoxia awareness training session and presenting at least one of a graphical representation of a flight profile for the hypoxia awareness training session, a video of the test subject during the hypoxia awareness training session, and a video of a document on which the test subject performs psychomotor testing during the hypoxia awareness training session.

In another embodiment, the invention is directed to a system including a network client that transmits a hypoxia awareness training request from a user via a network, and a network server that receives the hypoxia awareness training request via a network, wherein the network server directs a hypoxia awareness training session for the user in response to the hypoxia awareness training request.

In another embodiment, the invention is directed to a method, which includes accepting a hypoxia awareness training request via a global computer network, and directing a hypoxia awareness training session for a test subject in response to the hypoxia awareness training request.

In another embodiment, the invention is directed to a system including a hypoxia awareness training device that induces hypoxia in a test subject and displays at least one web page during a remote hypoxia awareness training session.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating one embodiment of a hypoxia awareness training system.

FIG. 2 is a block diagram of an exemplary hypoxia awareness training system.

FIG. 3 is a block diagram illustrating another embodiment of a hypoxia awareness training system.

FIG. 4 is a graph showing one example of a reduced-oxygen breathing paradigm simulated by the hypoxia awareness training system.

FIGS. 5A is an example document of psychomotor testing results of a test subject undergoing hypoxia awareness training.

FIG. 5B is an example color chart that may be used during a hypoxia awareness training session.

FIGS. 6A and 6B are block diagrams of a web-based embodiment of the hypoxia awareness training system.

FIGS. 7A-7J are screen illustrations of an example user interface with which a user interacts to carry out a hypoxia awareness training session.

### DETAILED DESCRIPTION

Altitude hypoxia is a hazardous physiological threat to flight crew and passengers when flying at altitude or to other subjects exposed to a high altitude terrestrial environment (mountaineers, tourists, troops). This type of hypoxia is caused by a decreased partial pressure of oxygen in the ambient atmosphere at altitude. The hypoxia awareness training system described herein simulates atmospheric oxygen concentrations found normally at sea level and at high altitudes, and can be programmed to reduce oxygen levels to correspond with specific altitudes. The rate of change in simulated altitude (oxygen reduction) can be programmed to correspond with normal ascent rates of specific aircraft, thus providing a platform for training pilots to recognize hypoxia symptoms of themselves or their crewmates. This training can be performed in a safe and controlled environment, where poor judgment and coordination will not result in disaster. The training may also be useful for other subjects who may be exposed rapidly to high altitude, such as mountaineers, tourists, or military personnel.

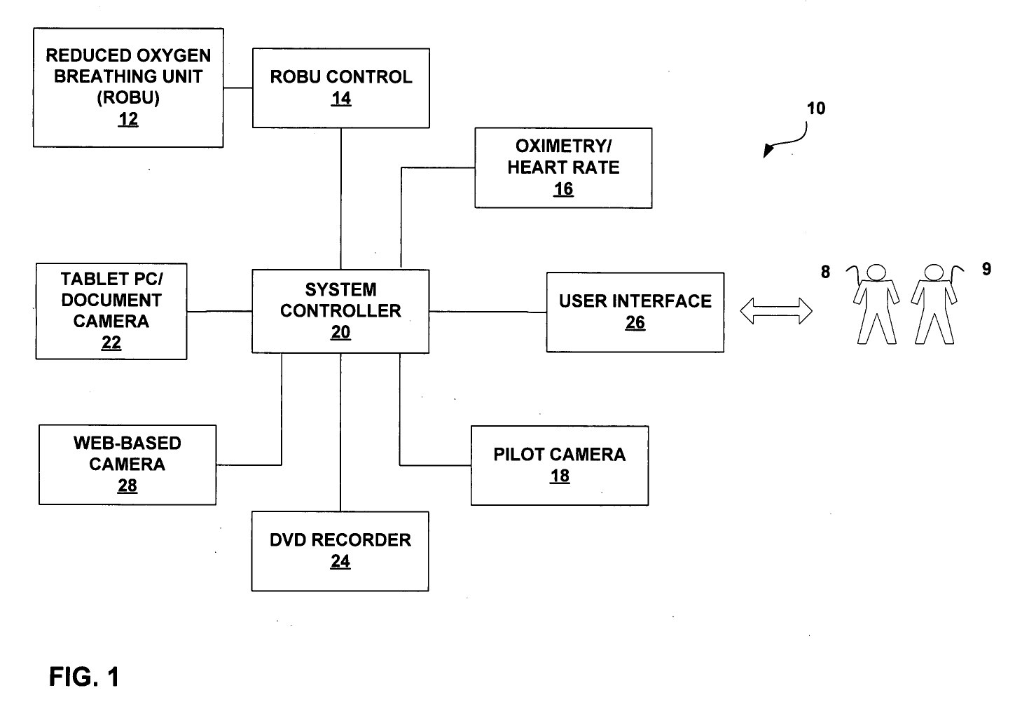

FIG. 1 is a block diagram illustrating one embodiment of a hypoxia awareness training system 10. System 10 exposes a test subject 8 to a reduced oxygen breathing paradigm in order to simulate the effects of a hypoxic environment under controlled conditions. When exposed to a hypoxic environment in a controlled fashion, the subject may experience hypoxic conditions and become familiar with their own subjective signs and symptoms of hypoxia. These signs and symptoms tend to be reproducible upon repeat exposures to hypoxic environments. The rationale for hypoxia awareness training is, therefore, the hope that aviation personnel will recognize hypoxia symptoms in themselves or their crewmates should they occur during an actual flight and take appropriate measures before incapacitation occurs. For example, supplemental oxygen may be used to combat altitude hypoxia, or, in the event of a depressurization or failure of an oxygen system, descent to lower altitudes (typically below 10,000 feet).

Test subject 8 may be any type of aviation personnel, such as pilot, co-pilot, or other flight crew. In one embodiment, a tender 9 or other qualified instructor is present during the hypoxia awareness training of test subject 8. Tender 9 directs the simulation and instructs subject 8 to carryout various psychomotor tests during the simulation. Test subject 8 and tender 9 may have a pilot/co-pilot relationship. In this way, each pilot, when acting as the tender for the other pilot, may learn the hypoxia symptoms experienced by their co-pilot. This increases the likelihood that a test subject will recognize hypoxia symptoms in themselves or their crewmates should they occur during an actual flight.

Hypoxia awareness training system 10 includes a Reduced Oxygen Breathing Unit (ROBU) 12 and ROBU control 14. System 10 also includes equipment 16 for monitoring oximetry and heart rate of the test subject 8, such as a pulse oximeter. System 10 further includes a user interface 26 and system controller 20. A pilot camera 18 captures interaction of the test subject 8 during testing and training phase. A tablet PC and/or document camera 22 captures writing samples and other tabletop activities of pilot during the simulation. A hard drive or DVD recorder 24 records all captured media elements to make a record of the entire simulation experience. An omni-directional microphone picks up audio of voices and conversations during the training session. The recorded audio may be recorded and stored along with video sources to DVD, hard drive or other storage media. System 10 may further include a web-based camera 28 to aid in maintenance and troubleshooting for those embodiments where remotely deployed ROBUs are managed remotely via a web-based system.

The video of the test subject and the video of the document, as well as the flight profile being simulated, and/or other applicable information generated by the system may be displayed during the training session. This information may also be stored for review by the test subject in a post-simulation debriefing or for review at some future date. By capturing, displaying, and storing the entire training session experience, the test subject may be able to understand, learn, and retain much more information concerning the signs and symptoms of hypoxia in themselves and/or their crewmates. In addition, the test subject may be able to review the recorded training session at some future time to further understand and evaluate their individual reaction to hypoxia, or to undergo refresher training.

All of the system components, namely, ROBU 12, ROBU controller 14, pilot camera 18 and other peripheral devices, such as the tablet PC/document camera 222, DVD recorder 24, visual user interface 26 and equipment for monitoring oximetry and heart rate 16 are controlled by system controller 20. Software running in system controller 20 controls and coordinates operations of the other system components.

ROBU 12 is an open loop breathing device that delivers a reduced oxygen concentration to the test subject by diluting entrained room air with nitrogen. In one embodiment, the system consists of a plenum chamber, oxygen and nitrogen solenoids, mixing fan, oxygen analyzer and pulse oximeter. Upon selection of a flight profile by the user, a computer program controls the gas mixing within the chamber. Data feedback from the oxygen analyzer to the ROBU control 14 ensures precise ascent rate and altitude simulation. A single limb circuit connected to ROBU 12 supplies the mixed gas concentrations to a mask worn by the test subject. During the simulation the test subject's blood oxygen saturation and heart rate are continuously monitored via the pulse oximeter, which sends the data to the ROBU control 14.

In one embodiment, user interface 26 includes a touch-screen panel as the main interface for managing a hypoxia awareness training session. The touch panel abstracts the complexity of working with numerous technology components and allows the user to control cameras, video elements, and displayed information. User interface 26 incorporates a customized algorithm for managing step-by-step processes required in testing procedures. User interface 26 may also include a keyboard emulator to translate programmatic signals in the touch screen software that would otherwise need to be generated through computer keyboard commands.

In one embodiment, ROBU 12 may be like the device shown and described in U.S. patent application Publication US2003/0070678 A1, to Wartman et al., published Apr. 17, 2003, the entire content of which is incorporated herein by reference. In this embodiment of ROBU, a constant velocity fan provides a continuous flow of ambient gas through a mixing chamber. The oxygen concentration is reduced by a non-proportional pulsed flow of nitrogen by a simple on-off type gas valve. Feedback of oxygen concentration is provided via a sensor within the mixing chamber.

In another embodiment, ROBU 12 may be like the device described in the above-mentioned U.S. patent application Publication US2003/0070678 A1, to Wartman et al., published Apr. 17, 2003, but modified by reducing the plenum size to the four 90 degree connectors and the fan.

ROBU controller 14 and/or system controller 20 may be embodied as a computer-readable medium that includes instructions for causing a programmable processor to carry out the methods described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, a optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The invention may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above.

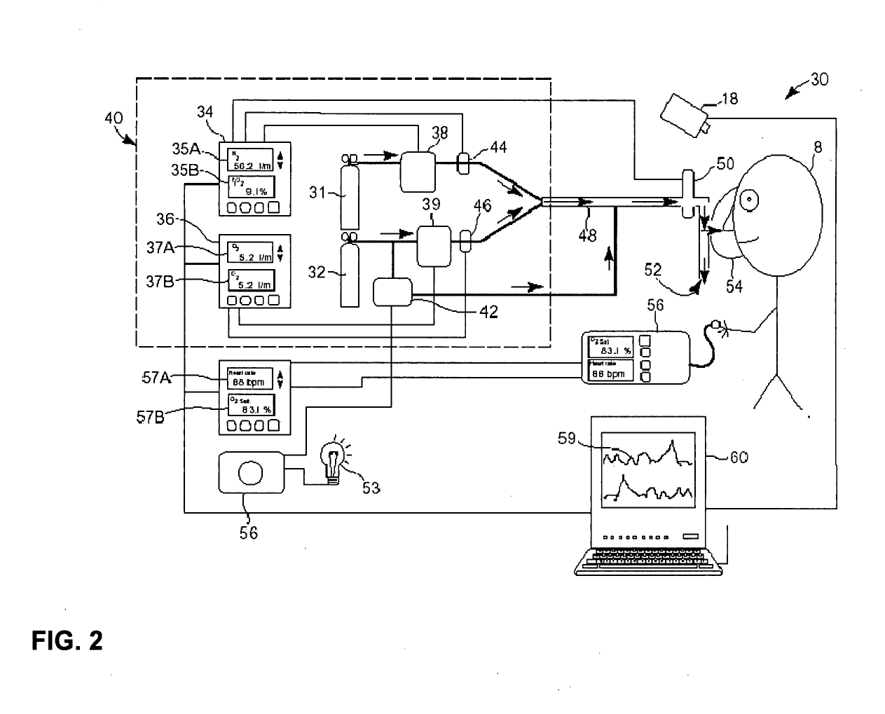

FIG. 2 is a diagram illustrating another embodiment of a hypoxia awareness training system 30. In use, test subject 8 breaths oxygen-reduced air provided by ROBU 40 through mask 54. Mask 54 is open to the atmosphere at opening 52. Pulse oximeter 56 the heart rate and oxygen saturation of the test subject 8, which may be displayed on displays 57A and 57B, respectively.

In the embodiment shown in FIG. 2, ROBU 12 uses high-pressure cylinders 31 and 32 of nitrogen and oxygen, respectively, to simulate a reduced oxygen environment. The gases are blended by two proportional solenoids, nitrogen (N₂) proportional solenoid 38 and oxygen (O₂) proportional solenoid 39. Constant feedback of the flow rates of these gases is provided via mass flow sensors 44 and 46 within each limb of the gas circuit. The final concentration of oxygen delivered is monitored by oxygen sensor 50, which is located near the test subject 8. N₂ controller 34 is connected to receive information concerning the oxygen concentration measured by O₂ sensor 50, and controls the flow rate of nitrogen from high-pressure cylinder 31 in response to the measured oxygen concentration. N₂ controller 34 also displays the actual N₂ concentration on display 35A, and displays the set point N₂ concentration (i.e., the target N₂ concentration at the currently simulated altitude) on display 35B. O₂ controller 36 controls the flow rate of oxygen from high-pressure cylinder 32, may display the actual O₂ concentration on display 37A, and may display the set point O₂ concentration (i.e., the target O₂ concentration at the currently simulated altitude) on display 37B. In one embodiment, O₂ controller 26 maintains the flow rate of both nitrogen and oxygen such that the total flow rate of the reduced-oxygen gas delivered to the test subject via gas delivery tube 48 is at least 40 liters per minute (1/m).

A PC 60 includes a display 59 that may display the simulated flight profile, video of the test subject from pilot camera 18 and/or video of any documents from tablet PC or document camera (not shown). PC 60 may also include an input device 61, such as a keyboard, that allows the test subject 8 or an associated tender (not shown) to enter login information. PC 60 thus allows a user to view training modules concerning aerospace physiology (including a description of the causes, signs, and symptoms of hypoxia), begin the simulation process, view the simulation during a debriefing process, record any DVDs of the training session, etc. An emergency oxygen flush unit 56 allows immediate delivery of 100% oxygen to test subject 8 at the conclusion of the simulation, or in the event that the physical condition of the test subject 8 indicates that the training session should be terminated. On/off solenoid 42 is connected to emergency oxygen flush unit 56 to allow delivery of the 100% oxygen. In the embodiment shown in FIG. 2, 100% oxygen indicator 58 illuminates when 100% oxygen is being delivered to test subject 8.

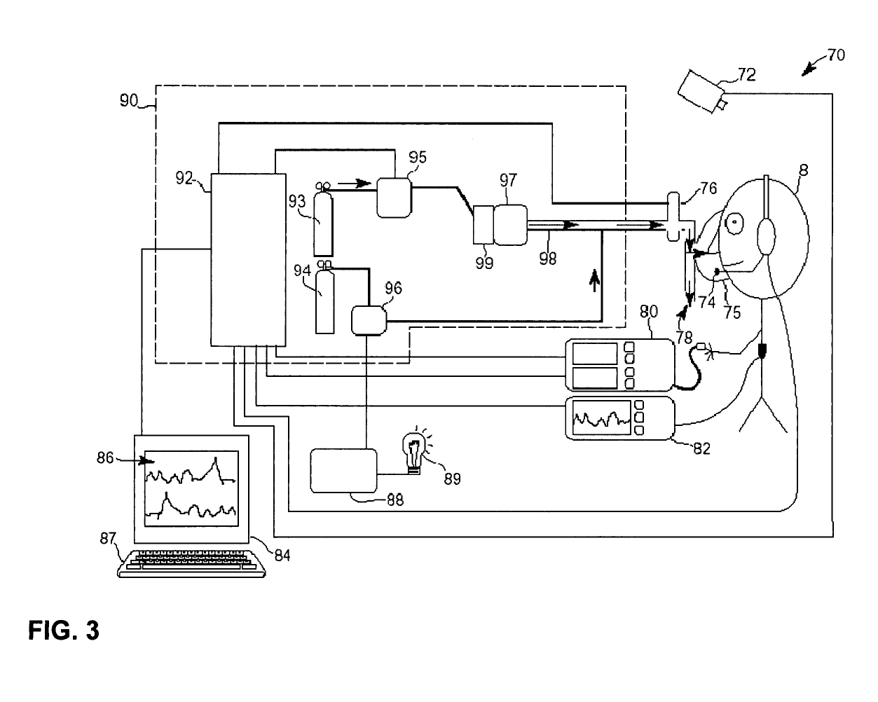

FIG. 3 is a diagram illustrating another embodiment of a hypoxia awareness training system 70. The ROBU 90 of FIG. 3 maintains a full closed loop proportional integral derivative control system. This embodiment uses a constant velocity turbine 99 to provide the bulk of the required gas flow. ROBU control 92 may achieve overall reduction in oxygen concentration in real time with a high-pressure nitrogen source 93 and electronic gas valve 95 (such as a proportional solenoid) under full proportional control. The two gases are mixed within a gas filter, such as a Heat/Moisture Exchange (HME) filter 97. This filter may provide the additional safety of supplying the pilot gas with particulate 0.5 microns and larger removed. The fraction of inspired gas delivered via gas delivery tube 98 to mask 75 is continually monitored via oxygen sensor 76 located proximal to the test subject. Gas delivery tube 98 is open to the atmosphere at opening 78. In this embodiment, the frequency response of the control loop for adjusting the oxygen saturation of the inspired gas is estimated to be approximately 150 milliseconds.

Like the embodiment of FIG. 2, system 70 may also include pulse oximeter 80 and electrocardiograph 82, which monitor the status of test subject 8, pilot camera 72, PC 84 with display 86 and keyboard 87, emergency oxygen flush unit 88, and 100% O₂ indicator 89. System 70 may also include a microphone 74 for recording audio of the training session.

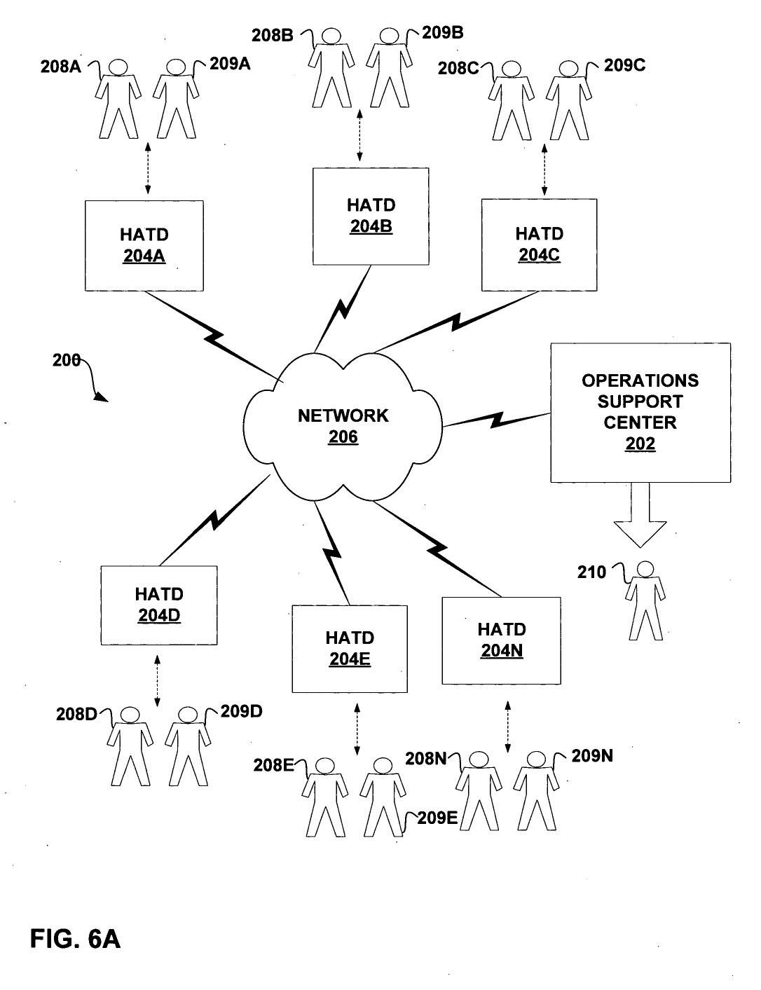

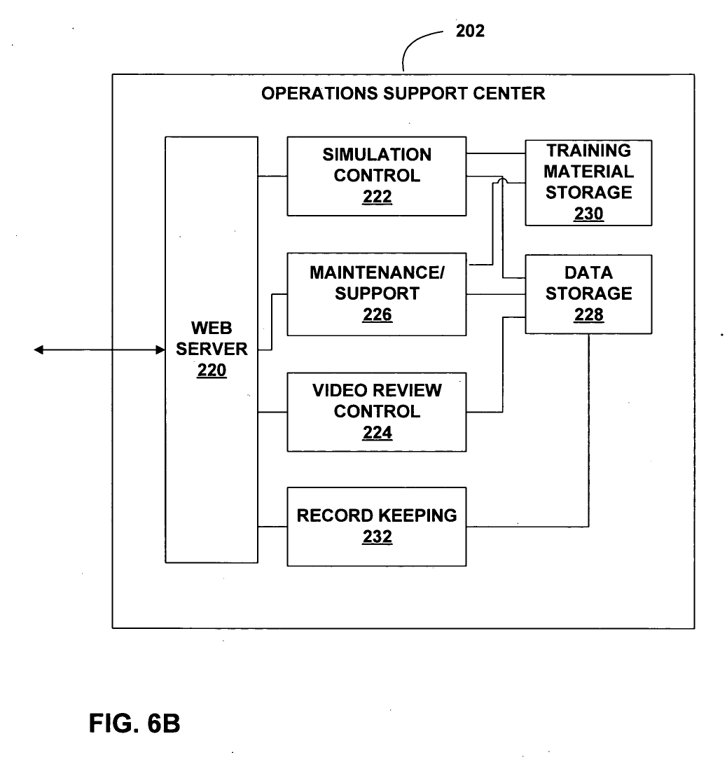

Although specific embodiments of the hypoxia awareness training system have been shown and described above, it shall be understood that neither the hypoxia awareness training system as a whole, the ROBU nor the ROBU control is limited to any one of the example systems described above, and that many other alternative embodiments are possible. For example, the gases can be derived from pressurized gas vessels, from gas concentrators or from liquid gas vaporizing sources. The system is scalable in that many different configurations could be used depending upon the size of the system desired and the number of test subjects to be trained at any one time. The system gas source could be smaller pressurized gas vessels for small systems, larger concentrator sources for medium systems, and liquid gas systems for large systems having many test subjects. In addition, although a standalone configuration is illustrated in FIGS. 2 and 3, the hypoxia awareness training system may also be configured as a web-based system as shown and described herein with respect to FIGS. 6A and 6B.

Referring again to the generalized block diagram of FIG. 1, ROBU control 14 controls the operation of ROBU 12. As a safety feature, ROBU control 14 is programmed to allow a simulation to run for a maximum specified period of time that is not under control of test subject 8, a tender 9, or other user. This ensures that test subject 8 is not subjected to reduced oxygen breathing levels for more than a predetermined safe period of time. For example, an authorized administrator may program ROBU control 14 via system controller 20 such that the simulation at altitude does not last more than a predetermined period of time.

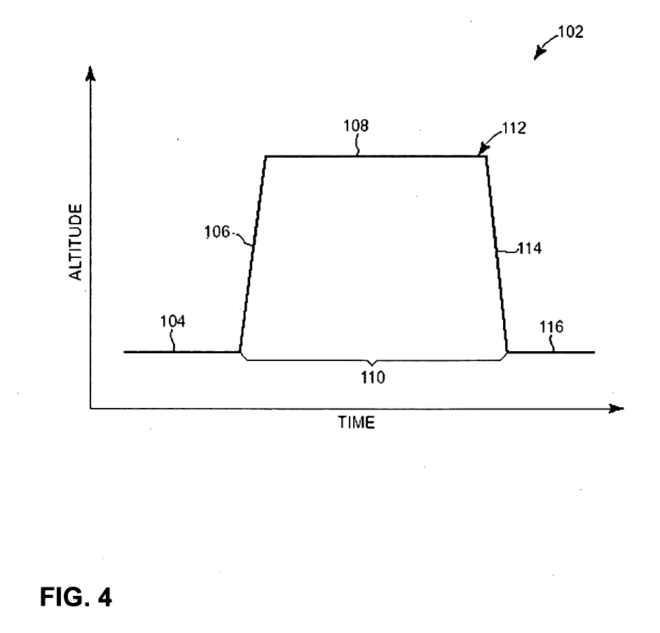

FIG. 4 is a graph showing an example flight profile 102 of the type that may be programmed into the hypoxia awareness training system 10. System 10 may store many different flight profiles, each corresponding to a different type of aircraft. The rate of change in simulated altitude (oxygen reduction) can be programmed to correspond with normal ascent rates of each of these different types of aircraft, thus providing a platform for training pilots to recognize symptoms of themselves or their crewmates under hypoxic conditions for any of several different types of aircraft. The particular aircraft whose flight profile is to be simulated may be chosen by the test subject, tender, or other user during the hypoxia awareness training session.

In the graph of FIG. 4, the horizontal axis represents time and the vertical axis represents altitude. The flight profile begins before take-off at zero altitude (104). The flight profile then simulates the ascent rate of a specific aircraft (106) before reaching the final altitude (108). This altitude is maintained for a specified duration, at which time the ROBU control 14 and ROBU 12 simulate the descent rate of the aircraft (114) before returning to zero altitude (116). In one embodiment, the predetermined period of time at altitude (and therefore under reduced oxygen breathing conditions) is comprised of 2.5 minutes of ascent to altitude, and then maintenance of that altitude for 5 to 5.5 minutes. The result is a total simulation time 110 of 7.5 to 8 minutes of exposure to hypoxic conditions. In one embodiment, the test time may not exceed 9 minutes of possible hypoxia exposure. As stated above, this maximum exposure time is not under control of the test subject, tender or other user other than an authorized administrator to prevent overexposure to reduced oxygen breathing levels.

A brief description of the actual training process of the hypoxia awareness training system will now be given. In use, a tender may initiate and run the simulation while the test subject (or subjects) undergoes a reduced-oxygen breathing paradigm controlled by the hypoxia awareness training system. Often, the tender and the test subject are in a pilot/co-pilot relationship. In this way, each pilot, when acting as the tender for the other pilot, may learn the hypoxia symptoms experienced by their co-pilot. This may increase the likelihood that hypoxia symptoms in themselves or their crewmates will be recognized should they occur during an actual flight.

Before the ascent to altitude (104) the test subject may be briefed with some basic information concerning hypoxia and the simulation is explained. For example, the test subject may be presented with a series of teaching modules to familiarize them with relevant aspects of high altitude flight operations and the pertinent aspects of aerospace physiology in that environment. For example, the flight physiology academics may include information concerning the principles of respiration within the human body, the definition, causes and mitigation of hypoxia, the effects of altitude on trapped gases, the potential for the occurrence of decompression sickness, the effects of prolonged oxygen use, and the effect of rapid decompression of the aircraft environment at altitude. This pre-simulation presentation serves to, among other things, educate subjects not familiar with the academics of flight physiology (such as those who have never undergone hypoxia awareness training) and to refresh experienced flight personnel with the subject matter.

During the simulation of the flight profile such as that shown in FIG. 4, the test subject is exposed to a reduced oxygen breathing paradigm that simulates the reduction in oxygen concentrations at the simulated altitudes (106). Once the desired altitude has been reached and is being maintained (108), the test subject undergoes various types of psychomotor testing. For example, the test subject may be asked, under direction of a tender or by other means, to write their name, address, phone number or other personal information at periods of time throughout the test. The test subject may also be asked to reproduce and draw a clock face indicating the current time of day, draw simple figures, perform serial subtractions or other mathematical operations, etc. The test subject may be asked to write down his or her own subjectively perceived symptoms, as they are experienced. Color vision demonstrations may also be performed during the simulation. Yet another test may require the test subject to repeat back and/or write a series of air traffic control messages. The document camera captures video of the writings of the test subject while the pilot camera captures video of the test subject. A microphone may further pick up audio of voices and conversations during the simulation phase. Typically, the psychomotor tests indicate reduced ability to perform these functions as exposure to the reduced oxygen breathing paradigm continues.

After the simulation at altitude has been maintained for the requisite period of time, the test subject is exposed to 100% oxygen (112) to bring them out of the hypoxic conditions at a rate that is safe to the subject. During the 100% oxygen phase of the test, the test subject may be asked to perform a color vision demonstration, usually with a marked increase in color contrast as seen on a color wheel. Because the reduction in color vision during the maintenance phase of the training session occurs more slowly over a longer period of time, any loss in color vision during that period may be much more subtle and not noticed by the test subject. However, upon exposure to 100% oxygen, the return of color vision is typically immediate and striking.

Once the simulation at altitude is completed (116), the test subject is debriefed. The debriefing may include a viewing of the simulation, including the video captured by the pilot camera and document camera and audio captured by the microphone. The test subject is therefore able, immediately following the simulation while the experience is still fresh in their mind, to view their own performance while exposed to the hypoxic conditions. The tender may talk the test subject through the changes that occurred and/or call out specific symptoms for that particular individual. Through review of their performance and symptoms experienced under hypoxic conditions, the test subject is able to learn their own hypoxia symptoms so that they can be recognized in the event of a hypoxic situation during an actual flight. By capturing, displaying, and storing the entire training session experience, the test subject may be able to understand, learn, and retain much more information concerning the signs and symptoms of hypoxia in themselves and/or their crewmates.

A DVD of the experience may also be recorded at this time, the experience may be recorded to a hard drive, or the experience may be recorded and maintained by a centralized server. The creation of a recorded experience immediately available for viewing not only serves to educate the test subject regarding their own signs and symptoms of hypoxia, but may further result in increased retention of the information learned during the training session. Recording the training session experience also allows the test subject to further review, analyze, and evaluate the experience at a later date or to undergo refresher training.

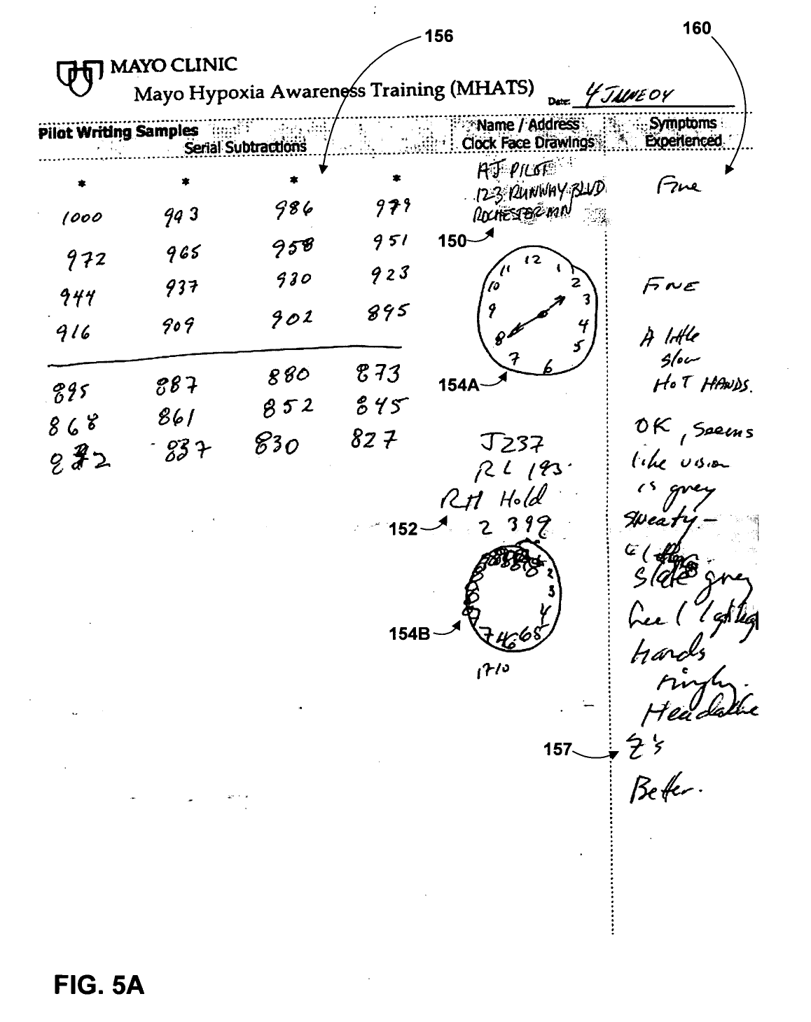

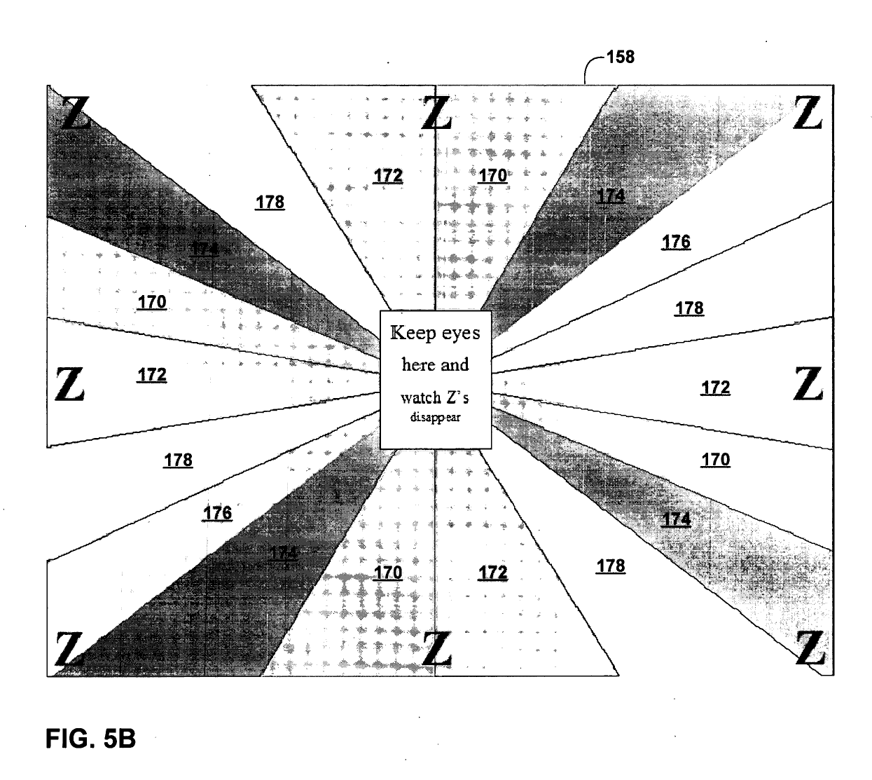

FIG. 5A shows an example document showing the results of the psychomotor testing generated by a test subject while undergoing a hypoxia awareness training session such as that described above. A tender or qualified instructor leads the test subject through a series of psychomotor tests designed to reveal and illustrate the effects of hypoxia on the test subject. Once the simulation to altitude begins, the tender instructs the test subject is to write their name, address, etc. as indicated by reference numeral 150. The test subject may also be instructed to draw a reproduction of a clock face 154A indicative of the current time of day. The test subject may also be asked to perform a series of mathematical operations 156, in this case serial subtractions by 7 starting at 1000. At various points in time during the training session, the tender may instruct the test subject to note any symptoms that they are experiencing (160). Near the end of the training session, the tender may direct the test subject to write their name and address and/or draw simple figures or reproduce a clock face again (154B). After the programmed period of time at altitude has elapsed, 100% oxygen is delivered to the test subject. Alternatively, if signs of acute hypoxia appear before the specified time has elapsed (such as twitching, repetitive writings, etc.) the tender may terminate the training session at any time and deliver 100% oxygen to the test subject.

At the time that 100% oxygen is delivered, the test subject may also undergo other psychomotor tests such as a color demonstration, indicated in the test pilot's notes of FIG. 5A by reference numeral 157. An example color demonstration is shown in FIG. 5B. FIG. 5B shows a color chart 158 of the type commonly used by the U.S. government (FAA) for its color vision alterations under hypoxia demonstrations in altitude chambers. Color chart 158 consists of a series of colors radiating from a central point (in this example, the colors are orange 170, blue 174, green 176, yellow 178, and fuchsia 172), with several capital letter “Zs” surrounding the periphery.

When used with the hypoxia awareness training system described herein, the test subject views color chart 158 (under reduced ambient light conditions) at the time that 100% oxygen is delivered. As the test subject breaths the 100% oxygen air, a sudden and dramatic increase in color perception, contrast, and separation is experienced. Also, any tunnel vision, a common symptom of hypoxia, is also alleviated, at which point the Z's surrounding the periphery of color chart 158 which were could not be seen while hypoxic are revealed.

Another striking psychomotor test consists in asking the subject to estimate when 30 seconds have elapsed without the assistance of a clock or watch under the condition of hypoxia. The influence of hypoxia will result in a significant distortion of the subject's ability to correctly approximate the time frame of 30 seconds.

Typically, the results of the psychomotor testing and the captured audio and video of the experience show a marked reduction in ability to perform the tested physical and cognitive functions. For example, FIG. 5A shows a marked decrease in handwriting alignment and legibility as the training session progresses. Notably, the test subject's drawing of the clock face near the end of the training session (154B) illustrates one of the hallmarks of acute hypoxia, repetition. (Note the repetition of the numeral “8” around the left and top portions of the clock face).

Another test that may be performed involves air traffic control messages. A co-pilot may read a series of air traffic control messages to the test subject. The test subject is to repeat the air traffic control message back to the co-pilot. The test subject may take notes (152) and then attempt to read the notes back to the co-pilot. Typically, the test subject cannot accurately repeat the messages after hearing them, cannot accurately write the messages down as they hear them, and cannot accurately read back their notes during this portion of the training session. For example the air traffic control message given to the test subject of FIG. 5A is as follows:
ExecJet 457 cleared to Rochester, Hold north on J two three zero, five mile leg, right turns, expect further clearance one niner three niner, anticipate additional two zero minute terminal delay.

Test subject notes 152 of FIG. 5A indicate that this particular test subject failed to properly record this air traffic control message. For example, the test subject noted “J237” instead of “J230” as given in the message. This type of psychomotor testing may thus be quite illustrative of the effects that hypoxia has on the test subject.

Although specific psychomotor tests have been shown and described, it shall be understood that many other types of tests may also be given to illustrate the effects of hypoxia on the test subject.

FIGS. 6A and 6B illustrates a web-based embodiment of the hypoxia awareness training system 200. FIG. 6A is a block diagram illustrating an example hypoxia awareness training system 200 in which a plurality of users, such as test subjects 208A-208N (collectively “test subjects 208”), tenders 209A-209N (collectively “tenders 209”) or other users interact with an operations support center 202 to perform hypoxia awareness training sessions. In the system shown in FIG. 6A, operations support center 202 is communicatively coupled to a number of remotely located Hypoxia Awareness Training Devices, or HATDs, 204A-204N (collectively, “HATDs 204”) by a network 206, such as the Internet. System 200 is scalable to allow for several hundred deployed HATDs 204 to be a part of the system.

The web-based system 200, in particular, may allow remote hypoxia awareness training via a network 206. Each HATD 204 is configured to provide a user, such as test subject 208, tender 209, or other user with remote access to an operations support center 202 via network 206, such as a local area network (LAN), a wide area network (WAN), or a global network such as the Internet. Operations support center 202 includes a network server, e.g., a web server 220 (see FIG. 6B), which can accept a training request from a user via the global computer network. In response to the training request, the operations support center 202 controls a hypoxia awareness training session for the user via the remotely deployed HATDs 204.

Users interact with their respective HATDs 204 to initiate and receive hypoxia awareness training. In one embodiment, remotely deployed HATDs 204 are similar to the hypoxia awareness training system shown in FIG. 1. For example, the remotely deployed HATDs 204 may include an ROBU 12, ROBU control 14, system controller 20, tablet PC/document camera 22, web-based camera 28, pulse oximeter 16, pilot camera 18, and user interface 26. In a web-based embodiment 200 such as that shown in FIG. 6, system controller 20 may be, for example, a PC or laptop computer configured to communicate with the operations support center 202 via the global computer network 206. In this embodiment, each remotely deployed HATD 204 acts as a network client that transmits a hypoxia awareness training request from a user via a global computer network, and operations support center 202 acts as a network server that receives the hypoxia awareness training request via the global computer network and directs delivery of hypoxia awareness training to the user in response to the hypoxia awareness training request.

Operations support center 202 may reside at a centralized provider location, with the provider responsible for security infrastructure and securing the pathways to the server. Administrative personnel 110 have access to operations support center 202 to program the training sessions, perform maintenance, billing, and other functions that may be required to provide a web based service.

A web based service and support platform for hypoxia awareness training such as that shown in FIG. 6A may allow delivery of hypoxia awareness training in an efficient and cost effective manner while assuring high quality. HATDs 204 may be deployed in several different types of locations. For example, clusters of remote HATDs 204 may be deployed at various centralized locations in the United States and internationally such as academic flight training schools. In addition, HATDs 204 may also be deployed in various locations for companies that wish to provide hypoxia awareness training at company-specific operations center(s).

The web based hypoxia awareness training system 200 may be designed to assist in the centralized management of the hypoxia awareness training system, assuring quality, optimizing resources, and minimizing overhead and ongoing support costs. System 200 may be configured for remote monitoring, diagnostics, and support by administrative personnel 210, thus reducing the need for trainers or system support staff to travel to a site with deployed HATDs 204 to troubleshoot or fix problems, which may result in cost savings and opportunity costs. The system 200 may also capture essential data in a secure, centralized database to facilitate short and long-term record keeping, reporting, management needs, and reporting on system usage patterns. In one embodiment, the web-based system may be accessible from remote locations 24 hours a day, 7 days a week via secured access. The system further provides for centralized storage of training materials and training simulations.

FIG. 6B shows a block diagram of operations support center 202. Operations support center 202 may include a web-based portal and software client interface to provide access, control, monitor system quality and network/system performance, and manage in-house and remotely deployed HATDs 204. Operations support center 202 may also provide remote access to an individual's recorded hypoxia awareness training session (video clip) from remote locations via, for example, a web site. The user may be required to enter a username and password to view their recorded training session. A DVD may also be provided “on demand” by request to the operations support center 202 and sent to the pilot. Operations support center 202 includes a web server 220 to facilitate communication with remotely deployed HATDs 204. A cluster of two or more web servers 220 may be used to enhance response time and to guarantee system availability in case of failures.

A simulation control module 222 contains all control software necessary to remotely direct delivery of the hypoxia awareness training sessions. Video review control module 224 facilitates review of a test subject's recorded training session. Maintenance support module 226 allows administrative personnel 210 to update, query, troubleshoot, diagnose, and maintain the remotely deployed HATDs 204. In addition to administrative controls, operations support center 202 may provide management reports such as overall system quality, response times, volumes, and usage patterns by site, and billing information.

Web-based system 200 may also incorporate a quality assurance feedback process that requests or requires users to submit evaluation and feedback of their hypoxia awareness training experience. In one embodiment, quality assurance can be established as a requirement for completion of training, such that the ability for a pilot to review previous training experiences on the web would be restricted until feedback was documented as a required step in the training process.

Data storage 228 stores all recorded individual pilot hypoxia awareness training sessions. These recorded training sessions may be uploaded to central data storage 228 on a scheduled basis. For example, recorded training sessions may be batched at the end of a series of training simulations, or may be uploaded on a defined schedule such as the end of a workday. In one embodiment, a trainer or other designated user at the remote location may logon to the web site using their username and password to upload the recorded training sessions. In another embodiment, the recorded training sessions are uploaded automatically at defined periodic intervals.

Pilots or other users undergoing hypoxia awareness training may have the ability to log on and view their individual training results. System 200 may, for example, send a reminder notice on an annual basis to the pilot or other user to let them know they need to log on to the web site and review their recorded hypoxia training session. Other information may also be available on the web site, such as information regarding aerospace medicine, educational articles, pertinent links, etc. In addition, company “sponsors” of pilots who use system 200 have the ability to log on to see limited information such as total number of pilots trained, names, dates, etc.

Operations support center 202 may continually monitor system 200 to sample quality and reliability. For example, operations support center 202 may originate and terminate test calls to all HATDs (in-house and deployed) on an established maintenance schedule. The maintenance schedule may be based on projected volume and use, or may simply be on a defined periodic maintenance schedule.

The system 200 may generate real-time notification to the operations support center 202 if actual performance does not meet predetermined metrics or if there is a system failure. Administrative personnel 210 may therefore monitor activity and troubleshoot and resolve problems before the user (test subject or tender) notices any problem. A history of “systems” problems would also be logged for each deployed HATD 204.

The training materials may reside at the operations support center 202 in training material storage 230 to provide centralized data storage and management of the entire system. In this case, the training materials may be provided securely via the operations support center. Alternatively, the training materials may be stored locally on each deployed HATD 204, or may be provided at the remote locations in the form of a DVD or CD-ROM.

In one embodiment, the deployed HATDs 204 may perform limited diagnostics and storage of information. For example, they may monitor what is going on with the deployed HATD only, and/or may provide local backup of the hypoxia awareness training session.

Users 208/209 may interact with system 200 via a web site provided by operations support center 202. Through this web site, users 208/209 may obtain access to training materials, be able to request delivery of hypoxia awareness training sessions, or view suites of products or applications related to aerospace medicine. For example, the latest information on aerospace medicine topics of interest, video clips, etc. may be included on the web site.

Clients may have the ability to send comments or problem notices via email or via the web site, which will be directed to the operations support center 202. Information for companies will include total volumes of pilots/students trained as well as next training dates for each of their pilots/students. Pilots/students may be able to access their own training information as well as their next training date(s). Communication to Pilots/students regarding updates or changes to FAAR's and other Flight Regulatory Bodies would be directed via the operations website.

A record-keeping database 232 may function as a real-time event messaging and collection database. The record keeping database 232 stores all usage information required for customer support, billing, and office/management functions. The record keeping database server may provide the ability to send reminders to pilots/students and companies of the due date for their next training session.

Operations support center 202 may allow for the tracking of company information, including date of initial and subsequent contracts, contact information (name, address, phone, e-mail), and fee arrangements. Basic reporting information such as total number of pilots trained by year and year to date, average per day, week, month, year, and all-time, number for each location for a client, etc. may be built into the system to show patterns and trends. Billing statements may also be available on-line with e-mail notification to the company that their monthly statement is ready, eliminating the need for paper invoicing.

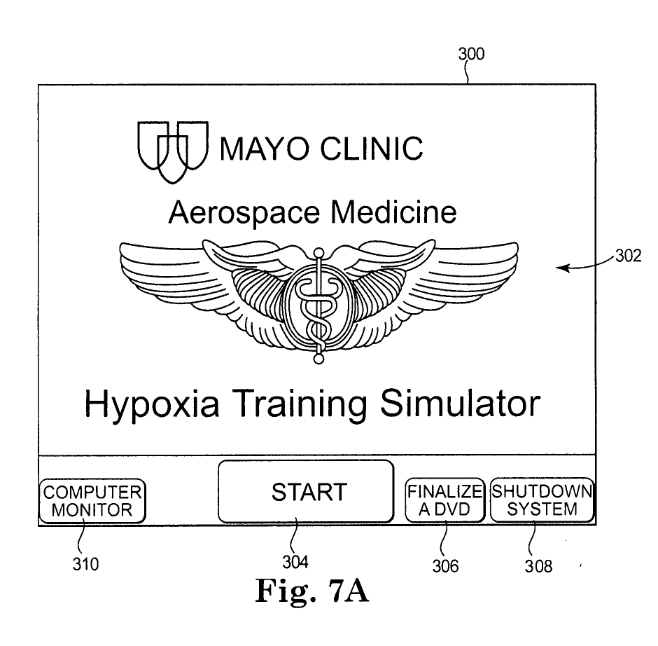

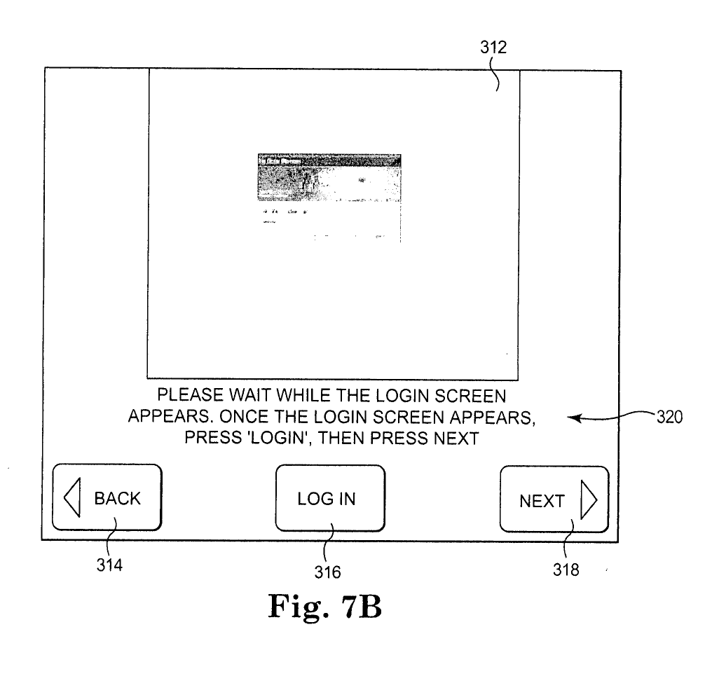

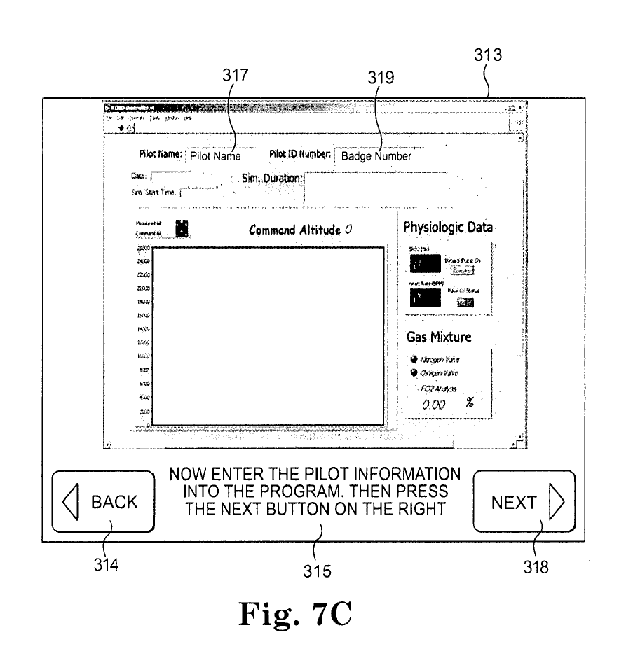

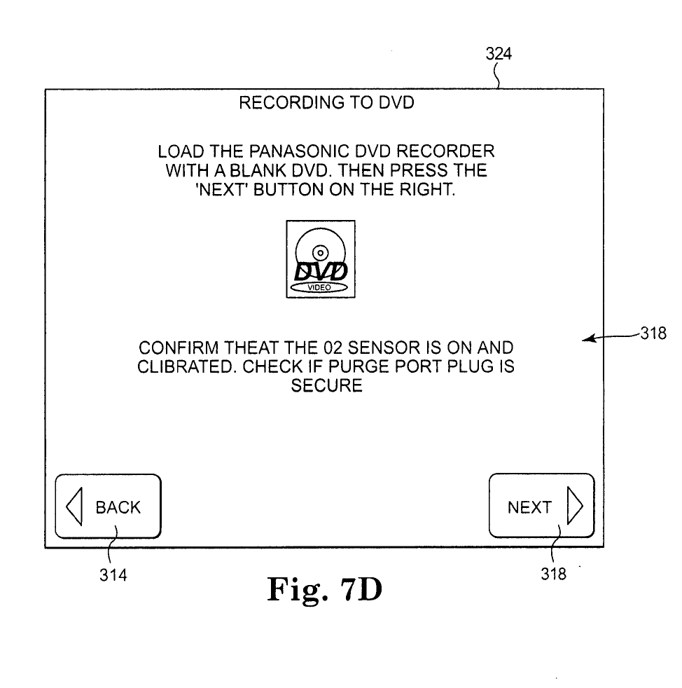

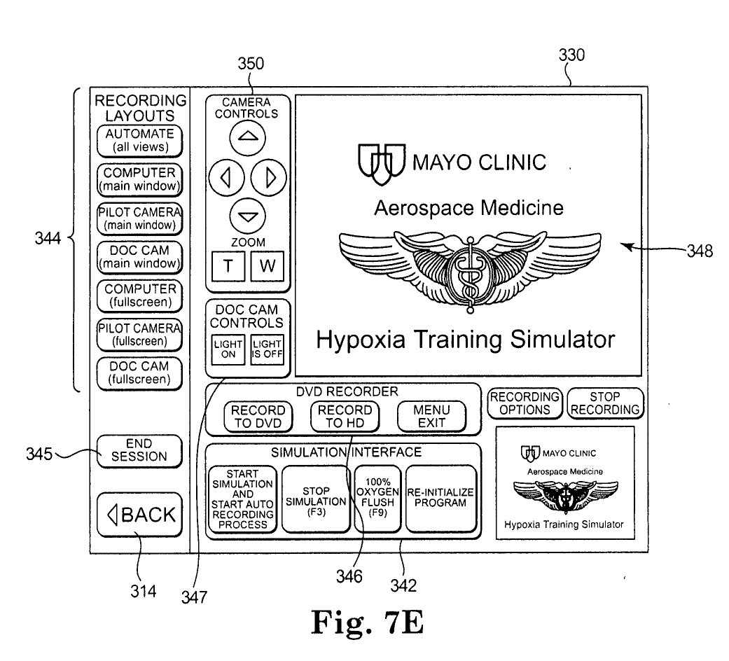

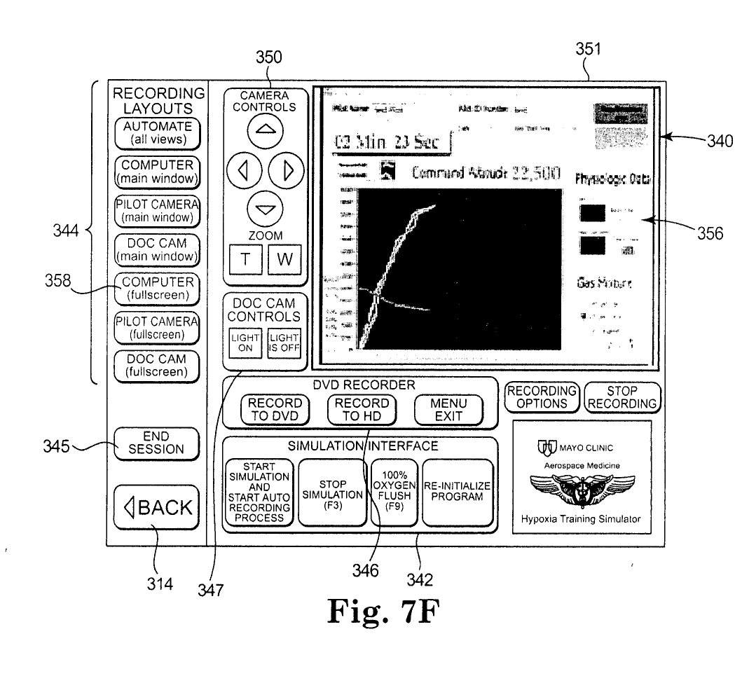

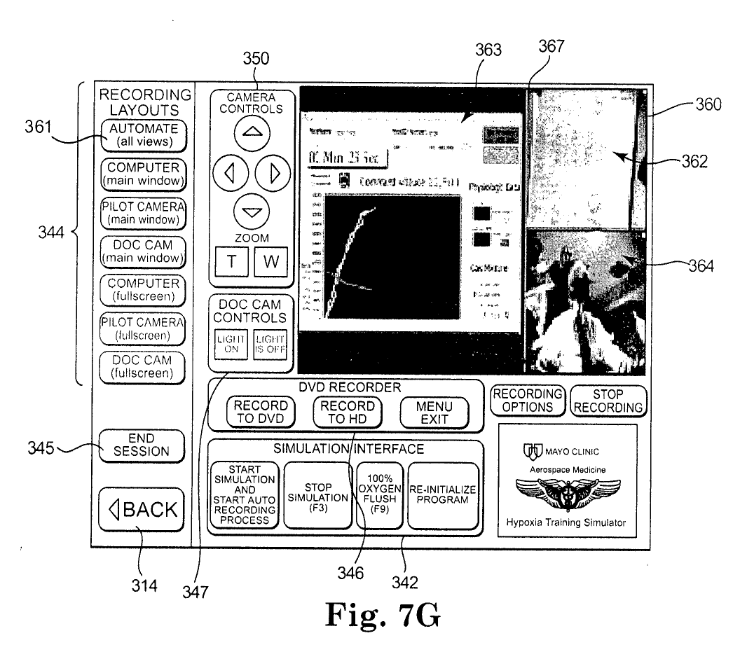

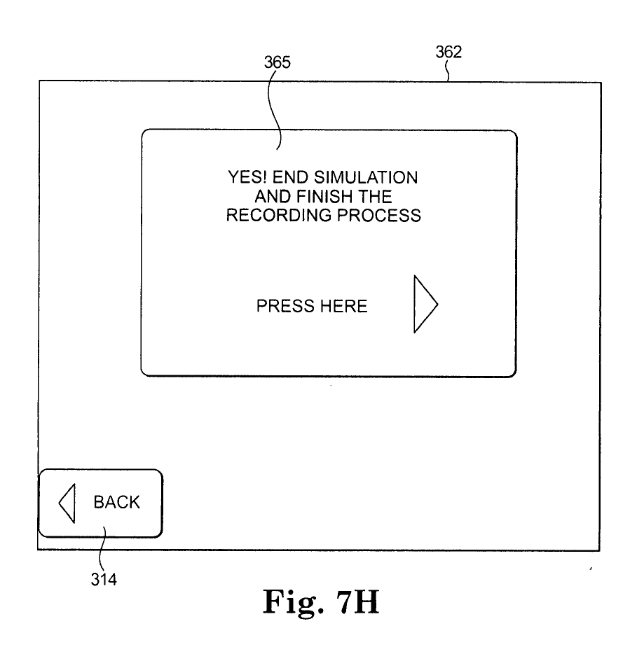

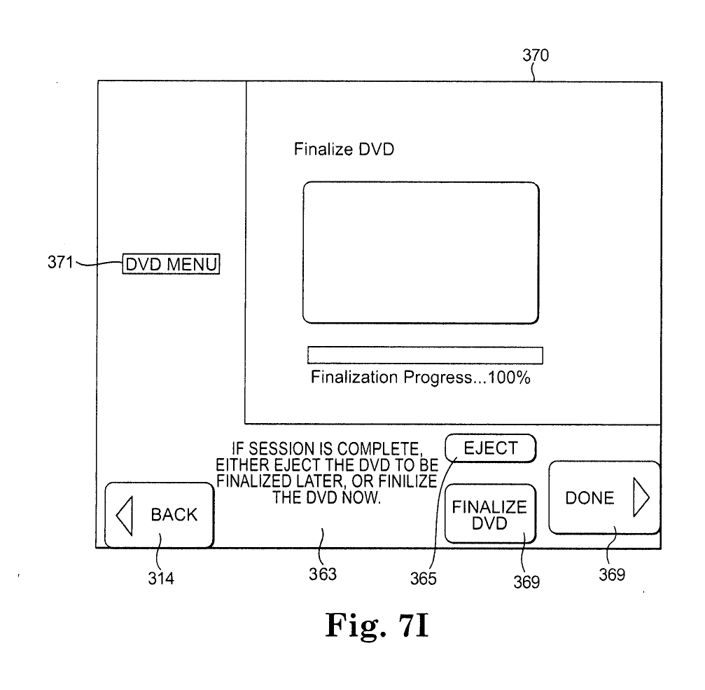

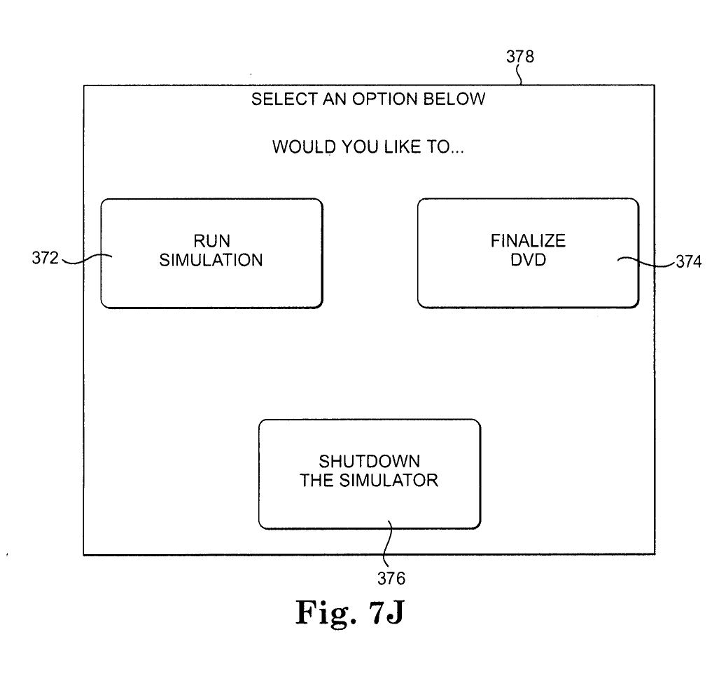

FIGS. 7A-7J are screen illustrations of an example user interface with which a user may interact to carry out a hypoxia awareness training session. In the event of a standalone hypoxia awareness training system, FIGS. 7A-7J illustrate example screen illustrations that may be displayed to a user via user interface 26 during an exemplary hypoxia awareness training session. In the event of a web-based system such as that shown in FIG. 6A, FIGS. 7A-7J illustrate various web pages generated by operations support center 202 and displayed to a user during an exemplary remote hypoxia awareness training session. Such web pages could be displayed via the desktop computers, laptop computers, interactive televisions, PDA's, Internet-equipped mobile phones, or other Internet appliance that form the user interface of remote HATD 204.

FIG. 7A is a screen illustration of an example user interface 300 with which a user, such as test subject 208, tender 209, or other user interacts to initiate a hypoxia awareness training session. An opening “splash” screen 302 is displayed on the visual user interface 300, which in this case is a touch screen panel. To initiate a training session, a user may press the START touch screen button 304. Other touch screen buttons may include computer monitor button 310, finalize DVD button 306, and shutdown button 308.

FIG. 7B is a screen illustration of an example user interface 312 with which a user may interact to begin the login process. FIG. 7B shows the login screen prompts 320, LOGIN button 316, BACK button 314, and NEXT button 318. FIG. 7C is a screen illustration of an example user interface 313 with which a user may enter the pilot information into the system. FIG. 7C shows login screen prompts 315, and spaces where the pilot may enter identifying information, such as their name (317) and pilot id number (319). The pilot information may be entered via a keyboard associated with the visual user interface. FIG. 7D is a screen illustration of an example user interface 324 showing record to DVD prompts and confirmation prompts 318.

FIG. 7E is a screen illustration of an example user interface 330 by which user interacts to control various aspects of a hypoxia awareness training session. Through this touch panel, user 208 and/or 209 may direct the start and stop of a simulation via the simulation interface 342, select and control the various system cameras (such as pilot camera 18, tablet PC or document camera 22) via pilot camera controls 350 and document camera controls 347, choose which data to be displayed in the viewing window 348 via recording layout controls 344, initiate or stop recording via DVD recorder controls 346, and end a training session via END SESSION button 345.

FIG. 7F is a screen illustration of an example user interface 351 in which touch screen button COMPUTER (full screen) 358 is selected, and the full screen computer view 356 is visible in the primary window 340. FIG. 7G is a screen illustration of an example user interface 367 in which touch screen button AUTOMATE (all views) 361 is selected, and all viewable entities are displayed in the primary window 360 (in this case the flight profile 363, the pilot camera 364, and the document camera 362). All viewable entities may be recorded to the DVD to record the training session experience.

FIG. 7H is a screen illustration of an example user interface 362 with which a user may interact via touch screen button 365 to end the simulation and finish the recording process.

FIG. 7I is a screen illustration of an example user interface 370 with which a user may interact to finalize recording on a DVD of the simulation experience. User interface 370 includes DVD menu button 372, finalize DVD prompts 363, eject touch screen button 365, finalize DVD touch screen button 369 and DONE touch screen button 369.

FIG. 7J is a screen illustration of an example user interface 370 with which a user may interact via touch screen buttons 372, 374, or 376 to either run another simulation with a new test subject, finalize a DVD, or shutdown the simulator, respectively.

Various embodiments of the invention have been described. These and other embodiments are within the scope of the following claims.

1. A system, comprising:
a reduced-oxygen breathing unit that induces hypoxia in a test subject during a training session; and
a pilot camera that captures video of the test subject during the training session.

2. The system of claim 1 further including a display that displays the video of the test subject during the training session.

3. The system of claim 1 further including a document camera that captures video of writings of test subject during the training session.

4. The system of claim 3 further including a display that displays the video of the writings of the test subject during the training session.

5. The system of claim 1 wherein the reduced oxygen breathing unit simulates a reduced oxygen breathing environment.

6. The system of claim 1 further including a programmable storage media for storing at least one of the video of the test subject during the training session and the video of the writings of the test subject during the training session.

7. A method, comprising:
inducing hypoxia in a test subject during a hypoxia awareness training session;
presenting at least one of a graphical representation of a flight profile for the hypoxia awareness training session, a video of the test subject during the hypoxia awareness training session, and a video of a document on which the test subject performs psychomotor testing during the hypoxia awareness training session.

8. The method of claim 7 further including storing at least one of the graphical representation of a flight profile for the hypoxia awareness training session, the video of the test subject during the hypoxia awareness training session, and the video of a document on which the test subject performs psychomotor testing during the hypoxia awareness training session.

9. The method of claim 7, wherein inducing hypoxia in a test subject includes simulating a reduced oxygen breathing environment corresponding to the flight profile.

10. The system of claim 7, further including directing the test subject to perform at least one of the following during the hypoxia awareness training session: writing their name and address, performing serial mathematical operations, reproducing a clock face, writing any symptoms that they are experiencing, performing a color demonstration, repeating an air traffic control message, and estimating when 30 seconds have elapsed without the assistance of a clock or watch.

11. A system, comprising:
a network client that transmits a hypoxia awareness training request from a user via a network; and
a network server that receives the hypoxia awareness training request via a network, wherein the network server directs a hypoxia awareness training session for the user in response to the hypoxia awareness training request.

12. The system of claim 11, wherein the network client is located remotely from the network server.

13. The system of claim 11, wherein the network is the Internet.

14. The system of claim 11, wherein the network server directs hypoxia awareness training sessions for a plurality of users via the network.

15. The system of claim 14, wherein the network server stores a plurality of recorded training sessions, each associated with a different one of the plurality of users.

16. The system of claim 14, wherein the network server provides the user with access to the associated recorded training session via the network.

17. The system of claim 11, wherein the network client includes a user interface that displays at least one web page to the user during a remote hypoxia awareness training session.

18. The system of claim 11, wherein the network client includes a reduced oxygen breathing unit.

19. The system of claim 18, wherein the network server controls the reduced oxygen breathing unit to deliver a reduced oxygen breathing paradigm to a test subject.

20. The system of claim 19, wherein the network server further includes a maintenance/support module by which maintenance personnel may remotely monitor, diagnose and maintain the remote reduced oxygen breathing units.

21. A method, comprising:
accepting a hypoxia awareness training request via a global computer network;
directing a hypoxia awareness training session for a test subject in response to the hypoxia awareness training request.

22. A system comprising a hypoxia awareness training device that induces hypoxia in a test subject and displays at least one web page during a remote hypoxia awareness training session.
